(19) United States
(12) Patent Application Publication
(10) Pub. No.: US 2017/0330690 A1
(43) Pub. Date: Nov. 16, 2017

(54) CONDUCTIVE PASTE AND MANUFACTURING METHOD THEREFOR

(71) Applicant: Murata Manufacturing Co., Ltd., Nagaokakyo-shi (JP)

(72) Inventors: Akitaka Doi, Nagaokakyo-shi (JP); Takehisa Sasabayashi, Nagaokakyo-shi (JP); Naoaki Ogata, Nagaokakyo-shi (JP)

(21) Appl. No.: 15/585,690

(22) Filed: May 3, 2017

(30) Foreign Application Priority Data
May 12, 2016 (JP) 2016-095760

(51) Int. Cl. H01G 4/30; H01G 4/012; C09D 7/12; C09D 5/24; C09D 7/00; H01G 4/248; C09D 201/00

(52) U.S. Cl. CPC H01G 4/308; H01G 4/248; H01G 4/012; C09D 201/00; C09D 5/24; C09D 7/1266; C09D 7/001; C09D 7/1275

(57) ABSTRACT

A conductive paste that includes conductive particles and a solvent. The solvent has a Hansen solubility parameter with an SP value of 24 to 39, a hydrogen bond term δh of 15 or more, and a polarity term δp of 7 or more. The conductive paste is applied to an unfired laminated body having laminated ceramic green sheets and internal electrode layers.

### CROSS REFERENCE TO RELATED APPLICATIONS

The present application claims priority to Japanese Patent Application No. 2016-095760, filed May 12, 2016, the entire contents of which are incorporated herein by reference.

### BACKGROUND OF THE INVENTION

### Field of the Invention

The present invention relates to a conductive paste and a method for manufacturing an electronic component, more particularly, to a conductive paste including conductive particles and a solvent, and a method for manufacturing an electronic component with the use of the conductive paste.

### Description of the Related Art

Electronic components, such as multilayer ceramic capacitors having laminated bodies with dielectric layers and internal electrodes and external electrodes formed through a step of applying and baking a conductive paste, are known. As such an electronic component, Japanese Patent Application Laid-Open No. 2015-173141 discloses a capacitor with a pair of electrodes formed on opposed longer sides of a laminated body.

### SUMMARY OF THE INVENTION

When such a laminated body is dipped in a conductive paste in order to form the external electrodes, the conductive paste may wet upward and extend onto unintended regions of the laminated body due to surface tension forces. If the conductive paste wets upward, there is the possibility that the distance between the pair of external electrodes has reduced to a degree that the insulation resistance is decreased. In addition, depending on the materials for use in the conductive paste, the ceramic green sheets may be damaged, or have so-called sheet attacks caused when the conductive paste is applied to the laminated body.

The present invention is intended to solve the problems mentioned above, and an object of the present invention is to provide a conductive paste which can prevent unnecessary upward wetting and sheet attacks, and a method for manufacturing an electronic component including external electrodes formed through a step of applying and baking the conductive paste.

The conductive paste according to the present invention includes conductive particles and a solvent. The solvent has Hansen solubility parameters of 15 or more in hydrogen bond term δh, 7 or more in polarity term δp, and 24 to 39 in SP value.

The solvent may include a glycol-based solvent.

In addition, the conductive paste may have a viscosity of 30 (Pa·s) to 70 (Pa·s) under conditions of a shear rate of 10 (1/sec) and a temperature of 25° C.

The conductive particles preferably contain at least one metal selected from the group of Ni, Cu, Ag, Pd, and an alloy of Ag and Pd.

The method for manufacturing an electronic component according to the present invention includes applying the above conductive paste to an unfired laminated body.

Preferably, the unfired laminated body is obtained by laminating ceramic green sheets including a binder that has a Hansen solubility parameter of 9 to 11 in hydrogen bond term δh, and electrode material layers for internal electrodes.

The method may further include applying an oil repellency treatment to the surface of the unfired laminated body before applying the conductive paste.

In addition, the method may further include firing the unfired laminated body with the conductive paste applied thereto.

The conductive paste according to the present invention can prevent upward wetting when the paste is applied because of the solvent having a Hansen solubility parameter of 15 or more in hydrogen bond term δh, 7 or more in polarity term δp, and 24 to 39 in SP value.

In addition, sheet attacks can be prevented from being caused when the conductive paste is applied to ceramic green sheets.

In addition, when the unfired laminated body includes a binder that has a Hansen solubility parameter of 9 to 11 in hydrogen bond term δh, it is possible to further prevent the conductive paste from wetting upward and prevent sheet attacks from being caused, thereby manufacturing a highly reliable electronic component without short circuits between external electrodes or damage to the laminated body.

### BRIEF DESCRIPTION OF THE DRAWINGS

FIG. 1 is a perspective view of a multilayer ceramic capacitor according to an embodiment;

FIG. 2 is a cross-sectional view of the multilayer ceramic capacitor shown in FIG. 1 along the line II-II;

FIG. 3 is a cross-sectional view of the multilayer ceramic capacitor shown in FIG. 1 along the line III-III; and

FIG. 4 is a flowchart showing the processing order of a method for manufacturing a multilayer ceramic capacitor.

### DETAILED DESCRIPTION OF THE INVENTION

Features of the present invention will be further specifically described below with reference to an embodiment of the present invention.

An embodiment will be described below for a conductive paste according to the present invention and a method for manufacturing an electronic component including external electrodes formed with the use of the conductive paste.

It is to be noted that in this embodiment, a multilayer ceramic capacitor will be described as an example of an electronic component including external electrodes formed by applying and baking the conductive paste according to the present invention.

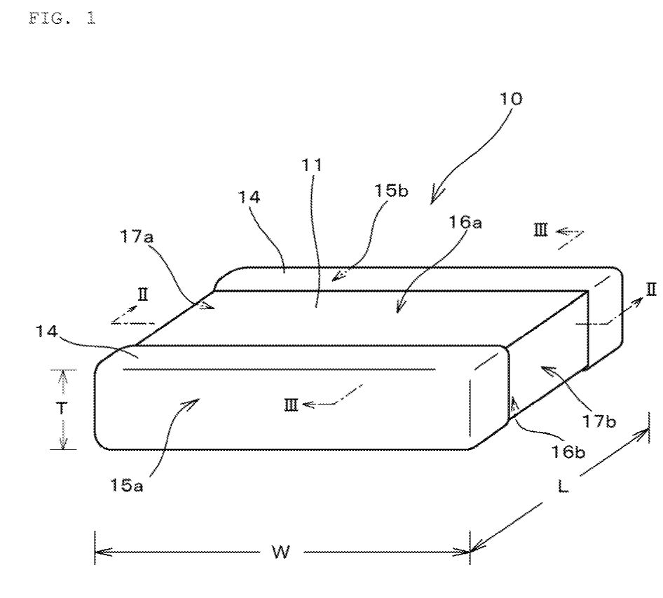

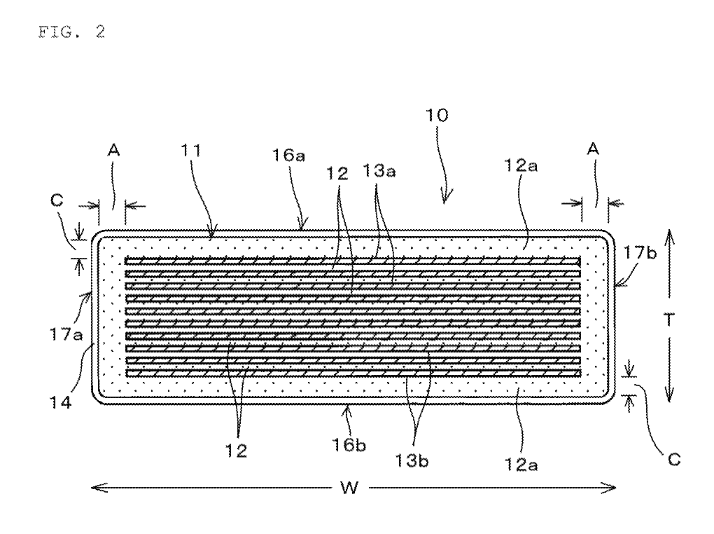

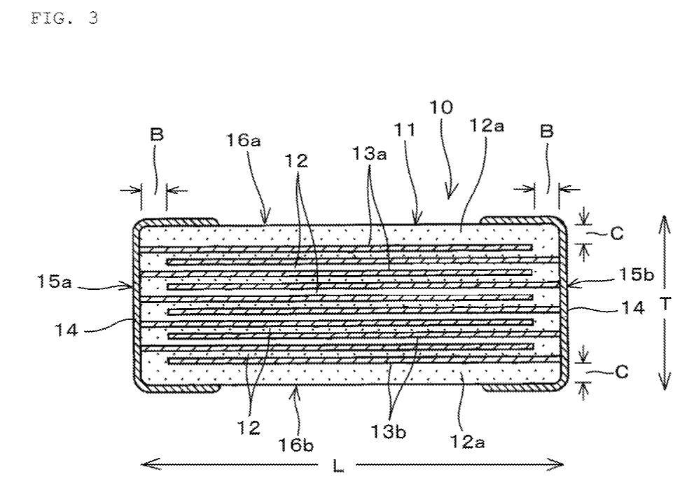

FIG. 1 is a perspective view of a multilayer ceramic capacitor 10 according to an embodiment. FIG. 2 is a cross-sectional view of the multilayer ceramic capacitor 10 shown in FIG. 1 along the line II-II. FIG. 3 is a cross-sectional view of the multilayer ceramic capacitor 10 shown in FIG. 1 along the line III-III.

As shown in FIGS. 1 to 3, the multilayer ceramic capacitor 10, which is an electronic component that has a cuboid shape as a whole, has a laminated body 11 and a pair of external electrodes 14.

As shown in FIGS. 2 and 3, the laminated body 11 includes alternately laminated dielectric layers 12, and as will be described later, first internal electrodes 13a that extend to a first end surface 15a of the laminated body 11 and second internal electrodes 13b that extend to a second end surface 15b thereof. More specifically, the multiple dielectric layers 12 and the multiple internal electrodes 13a, 13b are laminated alternately to form the laminated body 11.

In this regard, the direction in which the pair of external electrodes 14 is arranged is defined as the length direction of the multilayer ceramic capacitor 10, the direction in which the dielectric layers 12 and the internal electrodes 13 (13a, 13b) are laminated is defined as the thickness direction thereof, and the direction perpendicular to both of the length direction and the thickness direction is defined as the width direction thereof.

The laminated body 11 has, as described above, the first end surface 15a and second end surface 15b opposed in the length direction, and a first principal surface 16a and a second principal surface 16b opposed in the thickness direction, and a first side surface 17a and a second side surface 17b opposed in the width direction.

The laminated body 11 preferably has rounded corners and ridges. In this regard, the corner refers to the intersection of three surfaces of the laminated body 11, and the ridge refers to the intersection of two surfaces of the laminated body 11.

According to this embodiment, the length L is 0.1 mm to 2.0 mm, which is a dimension in the direction of connecting the first end surface 15a and second end surface 15b of the laminated body 11, the width W is 0.1 mm to 2.0 mm, which is a dimension in the direction of connecting the first side surface 17a and the second side surface 17b, and the thickness T is 0.05 mm to 0.3 mm, which is a dimension in the laminating direction of the laminated body 11. While the dimensions of the laminated body 11 are not limited to the sizes mentioned previously, the thickness T of the laminated body 11 is preferably 0.3 mm or less, and the width W thereof is preferably 0.1 mm or more. The dimensions of the laminated body 11 can be measured with an optical microscope.

It is to be noted that the laminated body 11 has substantially the same size as the size of the multilayer ceramic capacitor 10. Accordingly, it is possible to restate the size of the laminated body 11 explained in this specification as the size of the multilayer ceramic capacitor 10.

As will be described later, the internal electrodes 13 (13a, 13b) each have an opposed electrode part that is a part opposed in the laminating direction. In the laminated body 11, the width W dimensions of side parts located between the opposed electrode part of the internal electrode 13 and the first side surface 17a, and between the opposed electrode part of the internal electrode 13 and the second side surface 17b, that is, side gaps A are preferably 0.1 mm or more and 2.0 mm or less. In addition, in the laminated body 11, the length L dimensions are preferably 0.1 mm or more and 2.0 mm or less, between the opposed electrode part of the internal electrode 13 and the first end surface 15a, and between the opposed electrode part of the internal electrode 13 and the second end surface 15b.

Outer layer parts 12a that are dielectric layers located between the internal electrodes 13 to serve as the outermost layers in the laminating direction and the first principal surface 16a and second principal surface 16b of the laminated body 11 are 5 μm or more and 30 μm or less in thickness C.

The thickness of each dielectric layer 12 sandwiched by the pair of internal electrodes 13a, 13b is preferably 0.4 μm or more 2 μm or less.

The number of dielectric layers 12 is preferably 5 or more and 200 or less.

As a material for the dielectric layers 12, a dielectric ceramic can be used which contains a main constituent such as, for example, BaTiO₃, CaTiO₃, SrTiO₃, or CaZrO₃. In addition, these constituents may have accessory constituents such as an Mn compound, an Fe compound, a Cr compound, a Co compound, and an Ni compound added thereto, which are lower in content than the main constituent.

The laminated body 11 includes, as described above, the first internal electrodes 13a that extend to the first end surface 15a and the second internal electrodes 13b that extend to the second end surface 15b. The first internal electrodes 13a each include an opposed electrode part that is a part opposed to the second internal electrode 13b; and an extended electrode part that is a part from the opposed electrode part to the first end surface 15a of the laminated body 11. In addition, the second internal electrodes 13b each include an opposed electrode part that is a part opposed to the first internal electrode 13a; and an extended electrode part that is a part from the opposed electrode part to the second end surface 15b of the laminated body 11. The opposed electrode parts of the first internal electrodes 13a and the opposed electrode parts of the second internal electrodes 13b are opposed with the dielectric layers 12 interposed therebetween, thereby forming capacitance, and thus functioning as a capacitor.

The first internal electrodes 13a and the second internal electrodes 13b contain, for example, a metal such as Ni, Cu, Ag, Pd, an alloy of Ag and Pd, and Au. The first internal electrodes 13a and the second internal electrodes 13b may further include dielectric grains that have the same composition system as the ceramic included in the dielectric layers 12.

The number of the internal electrodes 13 is preferably 5 or more and 200 or less. In addition, the first internal electrodes 13a and the second internal electrodes 13b are preferably 0.3 μm or more and 1.0 μm or less in thickness.

In addition, the coverage that is the proportion of the internal electrodes 13 covering the dielectric layers 12 is preferably 70% or more.

In this regard, the thickness for each of the multiple dielectric layers 12 and the thickness for each of the multiple internal electrodes 13 can be measured by the following method. While a method for measuring the thickness of the dielectric layers 12 will be described below, the same applies to the method for measuring the thickness of the internal electrodes 13.

First, a cross section of the laminated body 11 perpendicular to the length direction, exposed by polishing, is observed with a scanning electron microscope. Next, the thickness of the dielectric layer 12 is measured on five lines in total: a center line along the thickness direction, which passes through the center in a cross section of the laminated body 11; and two lines drawn at regular intervals from the center line to each side. The average value for the five measurement values is regarded as the thickness of the dielectric layer 12.

It is to be noted that in order to obtain the thickness more precisely, the laminated body 11 is divided into an upper part, a central part, and a lower part in the thickness direction, such five measurement values as described above are obtained for each of the upper part, central part, and lower part, and the average value for all of the measurement values obtained is regarded as the thickness of the dielectric layer 12.

The external electrodes 14 are formed to cover the entire end surfaces 15a and 15b of the laminated body 11, and partial regions of the principal surfaces 16a and 16b and side surfaces 17a and 17b, which are closer to the end surfaces 15a and 15b.

The external electrodes 14 each include a base electrode layer, and a plated layer disposed on the base electrode layer.

The base electrode layer is composed of a baked electrode layer. The baked electrode layer is a layer including a metal, which may have one layer or multiple layers. The metal included in the baked electrode layer contains, for example, at least one of Ni, Cu, Ag, Pd, and an alloy of Ag and Pd. The thickest part of the baked electrode layer is preferably 0.5 μm or more and 20 μm or less in thickness.

The baked electrode layer is formed by applying a conductive paste to the laminated body 11, and baking the paste. Details of the conductive paste will be described later. The baked electrode layer includes dielectric grains, because the conductive paste and the internal electrodes 13 are respectively subjected to baking and firing at the same time by a co-firing method.

The plated layer disposed on the base electrode layer contains, for example, Cu. The plated layer may have one layer or multiple layers. The plated layer is preferably 0.5 μm or more and 20 μm or less in thickness per each layer.

The conductive paste used for forming the base electrode layers includes conductive particles and a solvent. This solvent preferably includes a glycol-based solvent. However, the solvent may be one of an ethylene glycol, a propylene glycol, a butylene glycol, and a mixed solvent thereof.

The solvent included in the conductive paste has a Hansen solubility parameter of 24 to 39 in SP value δ, and the Hansen solubility parameter has a hydrogen bond term δh, a polarity term δp, and a dispersion term δd as follows:

δh: 15 to 28

δp: 7 to 20

δd: 17 to 19

It is to be noted that the solubility parameter can be specified from the ratio of the solvent and the molecular weight of the solvent by analyzing the composition of the solvent in the conductive paste through gas chromatography, or with a gas chromatography mass spectrometer.

The conductive paste preferably has a viscosity of 30 (Pa·s) to 70 (Pa·s) under the conditions of a shear rate of 10 (1/sec) and 25° C. It is to be noted that the viscosity is measured with a rotational viscometer.

The conductive particles included in the conductive paste contain, for example, any of Ni, Cu, Ag, Pd, and an alloy of Ag and Pd, which are 0.05 μm to 0.5 μm in particle size.

In addition, as described above, the baked electrode layers include dielectric grains, and the dielectric grains are composed of, for example, BaTiO₃, which is 0.01 μm to 0.2 μm in grain size.

The ratio by weight of the dielectric grains to the sum of the conductive particles and the dielectric grains is 10 to 50 wt %.

The conductive paste preferably includes a binder. It is preferable to use, as the binder, one of a hydroxymethyl cellulose, a hydroxyethyl cellulose, a hydroxypropyl cellulose, and a polyvinyl alcohol. The binder has a Hansen solubility parameter of 15 or more, preferably in particular, 16 to 25 in hydrogen bond term δh.

In this regard, the hydrogen bond term, polarity term, and dispersion term of the Hansen solubility parameter of the solvent included in the conductive paste for the external electrodes 14 are denoted respectively by δh, δp, and δd, whereas the hydrogen bond term, polarity term, and dispersion term of the Hansen solubility parameter of the binder included in the ceramic green sheets are denoted respectively by δh′, δp′, and δd′. According to the present embodiment, the difference Δδ is 5 or more between the SP value δ of the Hansen solubility parameter of the solvent included in the conductive paste for the external electrodes 14 and the SP value δ′ of the Hansen solubility parameter of the binder included in the ceramic green sheets. Δδ can be calculated from the following formula (1).

Δδ=√{(δd′−δd)2+(δp′−δp)2+(δh′−δh)2} (1)

### Method for Manufacturing Conductive Paste

First, as solid constituents, a metallic powder, a ceramic powder, and a dispersant, and a solvent were mixed, thereby providing a first mill base, and this base was prepared along with balls in a resin pot of 1 L in volume. This prepared pot was subjected to a pot mill dispersion treatment by rotating the pot for 12 hours at a constant rotational speed, thereby providing first slurry.

Next, an organic vehicle with a binder and a solvent mixed in advance was added into the pot, thereby providing a second mill base, and the pot was further subjected to a pot mill dispersion treatment by rotating the pot for 12 hours at a constant speed, thereby providing second slurry.

Then, with the second slurry warmed, the slurry was subjected to pressure filtration at a pressure of 1.5 kg/cm² with the use of a membrane-type filter of 5 μm in opening, thereby providing a conductive paste.

### Method for Manufacturing Multilayer Ceramic Capacitor

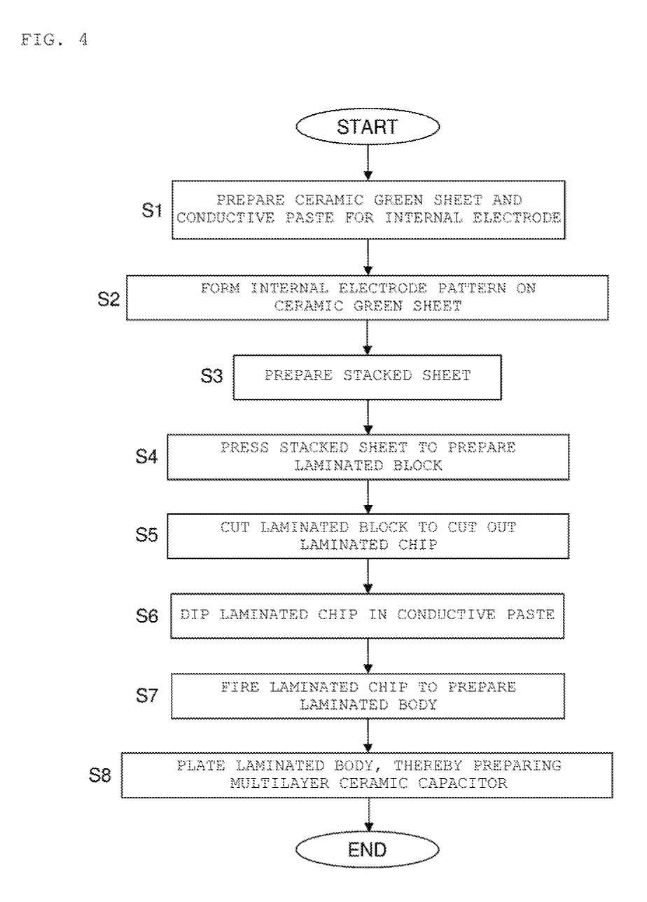

A method for manufacturing the multilayer ceramic capacitor 10 will be described with reference to FIG. 4.

In a step S1, prepared are: ceramic green sheets for forming the dielectric layers 12; and a conductive paste for forming electrode material layers for the internal electrodes 13. The ceramic green sheets can be formed by known methods. The ceramic green sheets include a binder and a solvent. The binder included in the ceramic green sheets is preferably one of a polyvinyl butyral-based resin and an ethyl cellulose-based resin, and the binder included in the ceramic green sheets preferably has a Hansen solubility parameter of 9 to 11 in hydrogen bond term δh′.

In a step S2, onto the ceramic green sheets, the conductive paste for the internal electrodes 13 is applied in predetermined patterns by for example, screen printing or gravure printing, thereby forming internal electrode oatterns.

In a step S3, the ceramic green sheets for outer layers without any internal electrode pattern formed are stacked to reach a predetermined number of sheets, the ceramic green sheets with the internal electrode patterns applied by printing are sequentially stacked thereon, and the ceramic green sheets for outer layers are further stacked thereon to reach a predetermined number of sheets, thereby preparing a stacked sheet.

In a step S4, the stacked sheet prepared is subjected to pressing in the staking direction by means such as isostatic press, thereby preparing a laminated block.

In step S5, the laminated block prepared is cut into a predetermined size, thereby cutting out a laminated chip that is an unfired laminated body. In this regard, the laminated chip may have corners and ridges rounded by barrel polishing or the like.

In addition, in order to prevent the conductive paste from wetting upward when the conductive paste is applied to the laminated chip in the subsequent step, the surface of the laminated chip cut out may be subjected to an oil repellency treatment. The oil repellency treatment is carried out by, for example, a coating method of applying an oil-repellent agent to the surface of the laminated chip.

In a step S6, regions of the laminated chip where the external electrodes 14 are to be formed are dipped in the above-described conductive paste for the external electrodes 14, thereby applying the conductive paste.

As described above, the difference Δδ is 5 or more between the SP value δ of the Hansen solubility parameter of the solvent included in the conductive paste for the external electrodes 14 and the SP value δ′ of the Hansen solubility parameter of the binder included in the ceramic green sheets. Thus, the binder included in the ceramic green sheets is not dissolved in the solvent included in the conductive paste.

In addition, the solvent included in the conductive paste for the external electrodes 14 has a Hansen solubility parameter of 15 or more in hydrogen bond term δh, thus increasing the surface tension of the conductive paste to the ceramic green sheets, and making it possible to make the contact angle 78 degrees of more. Thus, the conductive paste can be prevented from unnecessarily wetting upward.

In a step S7, the laminated chip with the conductive paste applied thereto is subjected to firing, thereby preparing a laminated body. In this case, the ceramic green sheets and the conductive paste for the external electrodes 14 are subjected to firing at the same time. The firing temperature is preferably 1000° C. to 1200° C., depending on the materials that form the dielectric layers 12 and the internal electrodes 13.

In a step S8, the laminated body prepared is subjected to Cu plating for the plated layers of the external electrodes 14. Thus, the multilayer ceramic capacitor 10 is obtained.

### Experimental Example

For multiple samples, multilayer ceramic capacitors herein, with external electrodes formed on ceramic green sheets with the use of conductive pastes including different types of solvents, products shaped defectively due to the conductive pastes wetting upward were sorted to check the shape percent defectives. Defective shapes were determined herein in the case of drawing, on principal surfaces, virtual lines connecting end edges of the external electrodes formed on end surfaces of laminated bodies to each other, and determining protrusions of the external electrodes formed on the principal surfaces from the virtual lines to be 35 μm or more. In addition, checked was whether there was any sheet attack on unfired laminated chips or not, that is, whether the ceramic green sheets were eroded by the solvents or not when the conductive pastes were applied to the ceramic green sheets. As for the corrosion, whether there was any corrosion or not was confirmed by visually checking the ceramic green sheets disposed as outermost layers.

Table 1 shows characteristics of the samples of sample numbers 1 to 8 for characterization. Table 1 shows the type of the solvent included in the conductive paste, the dispersion term δd, polarity term δp, and hydrogen bond term δh of the Hansen solubility parameter of the solvent, the SP value δ thereof, the difference Δδ between the SP value of the Hansen solubility parameter of the solvent and the SP value of the Hansen solubility parameter of the binder included in the ceramic green sheets, the contact angle of the conductive paste, the viscosity of the conductive paste, the shape percent defective of the sample, and whether any sheet attack was caused or not. However, in Table 1, the samples with the samples numbers marked with * refer to samples that fail to meet the requirements of the present invention: “the solvent having a Hansen solubility parameter of 15 or more in hydrogen bond term δh, and 7 or more in polarity term δp, and the solvent having a Hansen solubility parameter of 24 to 39 in SP value”, whereas the samples without * refer to samples that meet the requirements of the present invention.

TABLE 1

| | | | | | | | | | Shape | |
|---|---|---|---|---|---|---|---|---|---|---|
| | | | | | | | Contact | | Defective | |
| Sample | | | | | SP | Δδ | Angle | Viscosity | Percent | Sheet |
| Number | Solvent | δd | δp | δh | value δ | (PVB) | (°) | (Pa · s) | (%) | Attack |
| 1 | Ethylene Glycol | 19 | 20 | 28 | 39 | 23 | 99 | 65 | 0.1 | No |
| 2 | Propylene Glycol | 16 | 14 | 23 | 32 | 15 | 87 | 54 | 1.7 | No |
| 3 | 1,3 Butylene Glycol | 16 | 11 | 21 | 29 | 12 | 68 | 57 | 1.4 | No |
| 4 | Ethylene Glycol 1: | 17 | 7 | 15 | 24 | 5 | 78 | 52 | 6.9 | No |
| | Terpineol 3 | | | | | | | | | |
| 5 | Ethylene Glycol 1: | 17 | 7 | 15 | 24 | 5 | 78 | 30 | 9.8 | No |
| | Terpineol 3 | | | | | | | | | |
| 6 | Ethylene Glycol 1: | 17 | 7 | 15 | 24 | 5 | 78 | 25 | 12.6 | No |
| | Terpineol 3 | | | | | | | | | |
| *7 | Terpineol | 17 | 3 | 11 | 20 | 3 | 75 | 45 | 9.6 | Yes |
| *8 | Dihydroterpineol | 17 | 3 | 11 | 20 | 3 | 69 | 40 | 17.5 | Yes |

The sample of sample number 1 is adapted to use an ethylene glycol as the solvent included in the conductive paste. The conductive paste has a viscosity of 65 (Pa·s).

The sample of sample number 2 is adapted to use a propylene glycol as the solvent included in the conductive paste. The conductive paste has a viscosity of 54 (Pa·s).

The sample of sample number 3 is adapted to use 1.3 butylene glycol as the solvent included in the conductive paste. The conductive paste has a viscosity of 57 (Pa·s).

The sample of sample number 4 is adapted to use a mixed solvent of an ethylene glycol and a terpineol with a mixture ratio of 1:3, as the solvent included in the conductive paste. The conductive paste has a viscosity of 52 (Pa·s).

The sample of sample number 5 is adapted to use a mixed solvent of an ethylene glycol and a terpineol with a mixture ratio of 1:3, as the solvent included in the conductive paste. The conductive paste has a viscosity of 30 (Pa·s).

The sample of sample number 6 is adapted to use a mixed solvent of an ethylene glycol and a terpineol with a mixture ratio of 1:3, as the solvent included in the conductive paste. The conductive paste has a viscosity of 25 (Pa·s).

The sample of sample number 7 is adapted to use a terpineol as the solvent included in the conductive paste. The conductive paste has a viscosity of 45 (Pa·s).

The sample of sample number 8 is adapted to use a dihydroterpineol as the solvent included in the conductive paste. The conductive paste has a viscosity of 40 (Pa·s).

The samples of sample numbers 1 to 6 that meet the requirements of the present invention each have no sheet attack caused on the unfired laminated chip. In addition, for each of the samples of sample numbers 1 to 5, the conductive paste has a contact angle of 78 degrees or more with respect to the ceramic green sheets, and as the incidence of products shaped defectively due to the conductive paste wetting upward, the percent defective thus has a low numerical value. In particular, the samples of sample numbers 1 to 5 from the conductive pastes of 30 or more in viscosity all have percent defectives of less than 10% for defectively shaped products.

On the other hand, the sample of sample number 7 that fails to meet the requirements of the present invention has a sheet attack caused on the unfired laminated chip, because of the small difference Δδ between the SP value of the Hansen solubility parameter of the solvent and the SP value of the Hansen solubility parameter of the binder included in the ceramic green sheets, while the percent defective for defectively shaped products shows a relatively low numerical value. In addition, as for the sample of sample number 8 that fails to meet the requirements of the present invention, the percent defective for defectively shaped products has a high numerical value of 17.5%, and the sample also has a sheet attack caused on the unfired laminated chip.

The present invention is not to be considered limited to the embodiment described above. For example, while the multilayer ceramic capacitor has been taken as an example of an electronic component including external electrodes formed with the use of the conductive paste in the embodiment described above, the conductive paste according to the present invention can be applied to electronic components other than multilayer ceramic capacitors, and even applied to other than electronic components.

What is claimed is:

1. A conductive paste comprising:
conductive particles; and
a solvent having a Hansen solubility parameter with an SP value of 24 to 39, a hydrogen bond term δh of 15 or more, and a polarity term δp of 7 or more.

2. The conductive paste according to claim 1, wherein the hydrogen bond term δh is 15 to 28.

3. The conductive paste according to claim 1, wherein the polarity term δp is 7 to 20.

4. The conductive paste according to claim 1, wherein the solvent has a dispersion term δd of 17 to 19.

5. The conductive paste according to claim 1, wherein the hydrogen bond term δh is 15 to 28, the polarity term δp is 7 to 20, and the solvent has a dispersion term δd of 17 to 19.

6. The conductive paste according to claim 1, wherein the solvent comprises a glycol-based solvent.

7. The conductive paste according to claim 1, wherein the glycol-based solvent is one of an ethylene glycol, a propylene glycol, a butylene glycol, and a mixed solvent thereof.

8. The conductive paste according to claim 1, wherein the conductive paste has a viscosity of 30 (Pa·s) to 70 (Pa·s) under conditions of a shear rate of 10 (1/sec) and a temperature of 25° C.

9. The conductive paste according to claim 1, wherein the conductive particles include at least one metal selected from the group of Ni, Cu, Ag, Pd, and an alloy of Ag and Pd.

10. The conductive paste according to claim 9, wherein the conductive particles have a particle size of 0.05 μm to 0.5 μm.

11. The conductive paste according to claim 1, further comprising a binder.

12. The conductive paste according to claim 11, wherein the binder is one of a hydroxymethyl cellulose, a hydroxyethyl cellulose, a hydroxypropyl cellulose, and a polyvinyl alcohol.

13. The conductive paste according to claim 11, wherein the binder has a Hansen solubility parameter with a hydrogen bond term δh of 15 or more.

14. The conductive paste according to claim 13, wherein the binder has the Hansen solubility parameter with the hydrogen bond term δh of 16 to 25.

15. A method for manufacturing comprising:
preparing an unfired laminated body having laminated ceramic green sheets and internal electrode layers; and
applying, to the unfired laminated body, a conductive paste comprising:
conductive particles; and
a solvent having a Hansen solubility parameter with an SP value of 24 to 39, a hydrogen bond term δh of 15 or more, and a polarity term δp of 7 or More.

16. The method for manufacturing according to claim 15, wherein the ceramic green sheets include a binder that has a Hansen solubility parameter with a hydrogen bond term δh′ of 9 to 11.

17. The method for manufacturing according to claim 15, wherein a difference Δδ between the SP value of the Hansen solubility parameter of the solvent in the conductive paste and an SP value of a Hansen solubility parameter of the binder in the ceramic green sheets is 5 or more.

18. The method for manufacturing according to claim 15, further comprising applying an oil repellency treatment to a surface of the unfired laminated body before applying the conductive paste thereto.

19. The method for manufacturing according to claim 15, further comprising firing the unfired laminated body with the conductive paste applied thereto.
